(19) United States
(12) Patent Application Publication
(10) Pub. No.: US 2003/0165657 A1
(43) Pub. Date: Sep. 4, 2003

(54) Abrasive flooring material and method of making same

(76) Inventor: James N. Rockwell JR., LaGrange, GA (US)

Correspondence Address: Milliken & Company, P.O. Box 1927, Spartanburg, SC, 29304, US

(21) Appl. No.: 10/086,327

(22) Filed: Mar. 1, 2002

(51) Int. Cl. B32B 33/00; D05C 17/02

(52) U.S. Cl. 428/97; 428/95

(57) ABSTRACT

The present disclosure relates to a floor covering that is compatible for installation with surrounding carpet tiles, that is aesthetically compatible with surrounding carpet tiles, and that includes an abrasive component for removing dirt. The carpet tile of the present disclosure includes a monofilament component that aggressively dislodges dirt from pedestrian footwear. The carpet tile further includes a cushioned backing that increases the underfoot comfort to users thereof. The carpet tile can be made from solution dyed yarns or can be dyed or printed after construction.

### TECHNICAL FIELD

The present disclosure relates generally to floor covering articles, and, more specifically, to modular floor coverings. In particular, the present disclosure relates to modular floor coverings having an abrasive upper surface, which is intended to enhance the ability of the floor covering to remove dirt from pedestrian footwear, and a cushioned lower surface, which is intended to provide underfoot comfort to users thereof. The abrasive floor covering, as will be described herein, comprises a modular tile structure that may be installed in entryways or high traffic areas, in conjunction with ordinary (that is, non-abrasive) carpet tiles.

### BACKGROUND

All of the U.S. Patents cited herein are hereby incorporated by reference.

As an alternative to broadloom carpeting, modular carpet tiles may be used to provide underfoot cushioning and a decorative floor covering. Such carpet tiles have been produced for a number of years, and the technology surrounding their manufacture, installation, and aesthetics have progressively improved over time. Carpet tiles may be printed or dyed to match a variety of design requirements, as may be desired for use in public or private settings, such as hotels, casinos, restaurants, airports, offices, and homes.

Carpet tiles, in general, may be constructed of various multiple layers that are adhered, or otherwise attached, to one another. Examples of these layers include: a textile upper surface (which may be tufted or bonded); a primary backing (through which the textile surface is tufted); one or more stabilizing scrim layers; one or more adhesive layers; and one or more cushion layers. Variations in the weight of the carpet tile, the thickness of the backing, and the number and type of backing layers have also been developed and will be described herein.

To meet user needs for a pliant flooring article, a cushioned backing for carpet tiles was developed. U.S. Pat. Nos. 5,948,500 and 6,203,881, both to Higgins and commonly assigned, describe a modular carpet product having a cushioned backing layer comprised of compressible foam (such as polyurethane foam) and either a tufted or bonded upper layer. These carpet tiles, however, do not include the abrasive monofilament yarns described herein for the removal of dirt.

A floor covering that is compatible for installation with surrounding carpet tiles, that is aesthetically compatible with surrounding carpet tiles, and that includes an abrasive component for removing dirt would, therefore, represent an advancement over the prior art. Such a floor covering is described herein.

### SUMMARY

The present disclosure relates to a floor covering that is compatible for installation with surrounding carpet tiles, that is aesthetically compatible with surrounding carpet tiles, and that includes an abrasive component for removing dirt. The carpet tile of the present disclosure includes a monofilament component that aggressively dislodges dirt from pedestrian footwear. The carpet tile further includes a cushioned backing that increases the underfoot comfort to users thereof. The carpet tile can be made from solution dyed yarns or can be dyed or printed after construction.

### BRIEF DESCRIPTION OF DRAWINGS

FIG. 1 is a schematic of a process line for assembly of a carpet construction according to one embodiment of the present disclosure;

FIG. 2A is a cut-away side view of a tufted carpet with a cushioned composite structure;

FIG. 2B is a cut-away side view of a bonded carpet with a cushioned composite structure;

FIG. 3A is a cut-away side view of a carpet construction according to an embodiment of the present disclosure incorporating a loop pile tufted primary carpet surface;

FIG. 3B is a cut-away side view of a carpet construction according to another embodiment of the present disclosure incorporating a cut loop tufted primary carpet surface;

FIG. 3C is a cut-away side view of a carpet construction according to another embodiment of the present disclosure incorporating a bonded primary carpet surface;

FIG. 4 is a schematic process diagram illustrating an assembly process for forming a carpet construction according to one embodiment of the present disclosure;

FIG. 5A is a cut-away side view of an alternative embodiment of a loop pile tufted carpet construction including a multi-component backing composite;

FIG. 5B is a cut-away side view of an alternative embodiment of a cut pile tufted carpet construction including a multi-component backing composite; and

FIG. 5C is a cut-away side view of an alternative embodiment of a bonded carpet construction including a multi-component backing composite.

### DETAILED DESCRIPTION

The abrasive carpet tiles as described herein may be used in access ways where people tend to brush or scrape their feet to prevent carrying of moisture and/or dirt, accumulated on their footwear, into other areas of the building. Because of their location in high traffic areas, these abrasive carpet tiles must withstand repeated and heavy use. Generally, it is preferable for these abrasive carpet tiles to have the surface appearance of conventional carpeting, and it is especially preferable for these abrasive carpet tiles to have an appearance that is complementary to the surrounding carpeting.

In accordance with at least one embodiment of the present invention, a cushioned composite suitable for use as a floor covering is provided. As illustrated, tufted or bonded carpet constructions incorporate a layered arrangement of a pile forming primary fabric; a sheet of reinforcement material; and a layer of cushioning or foam, such as polyurethane foam, rebond foam, or compressed particle foam. These constructions may further include an optional backing layer or multi-component backing composite.

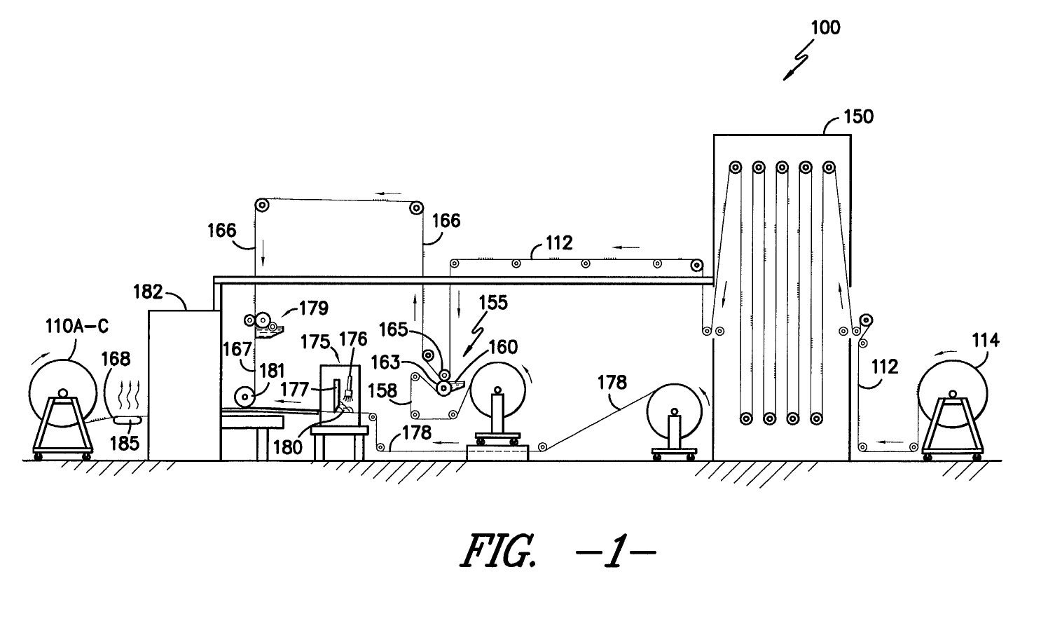

According to one exemplary in-line process for making cushion-backed carpet tiles, as shown in FIG. 1, a primary carpet fabric 112 (with or without a pre-coat underlayer) is conveyed by means of a plurality of rolls through an accumulator 150 to a reinforcement bonding unit 155. Simultaneously with the conveyance of the primary carpet fabric 112 to the reinforcement bonding unit 155, a sheet of reinforcement material 158 is likewise conveyed to the reinforcement bonding unit 155. The reinforcement material 158 is preferably fiberglass non-woven material, such as a 2.0 oz/yd² fiberglass that contains a urea formaldehyde binder, acrylic binder or the like, although alternative materials may include by way of example only, woven glass, woven polyester, non-woven glass, and non-woven polyester.

At the reinforcement bonding unit 155, an adhesive material 160 such as a hot melt polymeric adhesive is preferably applied to at least the top surface of the reinforcement material 158 by means of a film coater or other such unit as are well known. The coated reinforcement material 158 and the primary carpet fabric 112 are thereafter preferably passed in mating relation between joining members such as rolls 163, 165, thereby bonding the coated reinforcement material 158 to the underside of the primary carpet fabric 112. That is, the reinforcement material 158 is bonded on the side of the primary carpet fabric 112 from which the pile forming yarns do not project.

The bonding of the reinforcement material 158 to the underside of the primary carpet fabric produces a stabilized preliminary composite 166 to the underside of which another coating of adhesive material 160 is applied at a coating station 179 to substantially enclose the reinforcement material 158 within such adhesive material and to form a stabilized intermediate composite 167 which is thereafter laid into an adhesive, hotmelt, or a polyurethane-forming composition layer 180 on top of a preformed rebond foam layer 178 or directly onto the bare top surface of the foam layer 178 as described below.

Although the reinforcement bonding unit 155 is illustrated as incorporating a film coater, and the coating station 179 is illustrated as incorporating a vertical application roll, it is to be understood that any number of alternative means such as spray coaters, blade coaters, dip coaters, or the like may also be utilized. By way of example only, and not limitation, several alternative means for the application of adhesive 160 are disclosed in U.S. Pat. No. 4,576,665 to Machell.

According to a potentially preferred practice, while the preliminary composite 166 is being formed, a preformed rebond foam layer, composite, or sheet 178 is passed through a polymer application unit 175 which preferably includes a polymer discharge unit 176 and a doctor blade 177. The foam layer 178 is coated with an adhesive or polymer 180 such as a polyurethane-forming composition as disclosed more fully below.

As indicated, in the preferred practice, the polymer application unit 175 applies a deposit of a polymer 180 on the top of the cushion or foam layer 178, after which the height of the polymer layer is doctored to a desired level. In the preferred practice, the polymer applied is a polyurethane-forming composition based on a so-called soft segment pre-polymer of MDI (diphenylmethane diisocyanate) or an MDI derivative. The polyurethane-forming composition also preferably incorporates a silicone surfactant to improve both the frothability and stability of the polyurethane layer or “puddle” 180 which is spread across the surface of the preformed foam layer 178.

After disposition of the polyurethane-forming polymer 180 across the foam layer 178, the layer or “puddle” of the polymer 180 deposited is preferably doctored to a pre-determined height by means of a doctor blade 177 located at the polymer application unit 175. While a simple mechanical doctor blade is preferred, alternative equivalent means such as an air knife, a spray coater, a roll coater, or the like may also be used. Such an air knife is disclosed, for example, in U.S. Pat. No. 4,512,831 to Tillotson (incorporated by reference).

In one embodiment of the present invention, the intermediate composite 167 of the primary carpet fabric 112, which is preferably joined to the coated reinforcement material 158, can be laid directly into the polyurethane-forming composition 180 immediately after it is doctored to the appropriate level without any need to significantly heat either the intermediate composite 167 or the polyurethane-forming composition 180. Accordingly, the intermediate composite 167 and the foam layer 178 with the applied polyurethane-forming composition 180 may be simultaneously delivered at room temperature to a mating roll 181 immediately following the application and doctoring of the polyurethane-forming composition. As will be appreciated, the use of rebond foam as foam layer 178 reduces cost and produces a composite having a high recycled foam content. In the preferred process, at least one side of the intermediate composite 167 may be slightly preheated to improve operating control during lamination and curing, but such preheat is not essential to formation of the desired product.

In the illustrated embodiment of the in-line or in-situ carpet construction, the process described above results in the adhesive material 160 being laid adjacent to and extending away from the layer of cushioning foam 178 to the underside of the primary carpet fabric 112 with the layer of reinforcement material being embedded in intimate relation within the adhesive material 160 at a location intermediate the cushioning foam and the primary carpet fabric 112. Thus, at least a portion of the adhesive material 160 extends away from either side of the reinforcement layer 158.

Once the intermediate composite 167 has been laid into the polyurethane-forming composition 180, the resulting final composite 168 may be heated or cured in a heating unit 182 by means of conduction, radiant, or convection heaters as are well known in the art. Contact conduction heaters may be preferred. Such heating may be carried out at a temperature of between about 250° F. and about 325° F. for between about 2 minutes and 8 minutes.

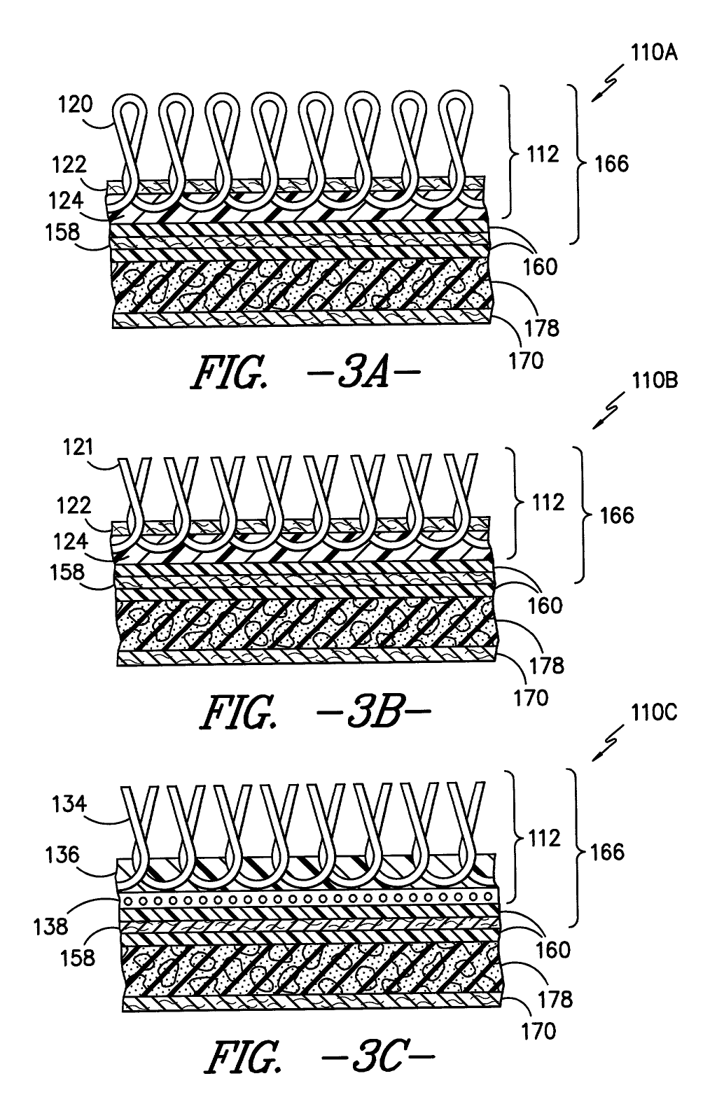

Following the heat curing operation, the resultant cushioned carpet composite 168 may be passed over a unidirectional heat source 185 such as a plate heater or roll heater at about 400° F. to fuse any outstanding fibers on the backing material 170 into a smooth surface. The carpet composite 110A, 110B, 110C (FIGS. 3A-3C) that is formed will thereafter be cooled, rolled, cut, sliced, or the like. When making carpet tiles, it is preferred that it be cut into carpet tiles almost immediately (rather than rolled) to avoid any undesired cupping or curl. After the carpet tiles are cut from the composite 168, they are printed or dyed, washed, fixed, dried, cooled, stacked, packaged, stored, and/or shipped to the customer.

The primary fabric will now be discussed. It is contemplated that the primary fabric may incorporate either a tufted or a bonded configuration, with loop and/or cut pile. It is also contemplated that the primary fabric may take on any number of other pile forming or non-pile forming constructions including, by way of example only, flat or textured fabrics having woven, knit, or nonwoven constructions.

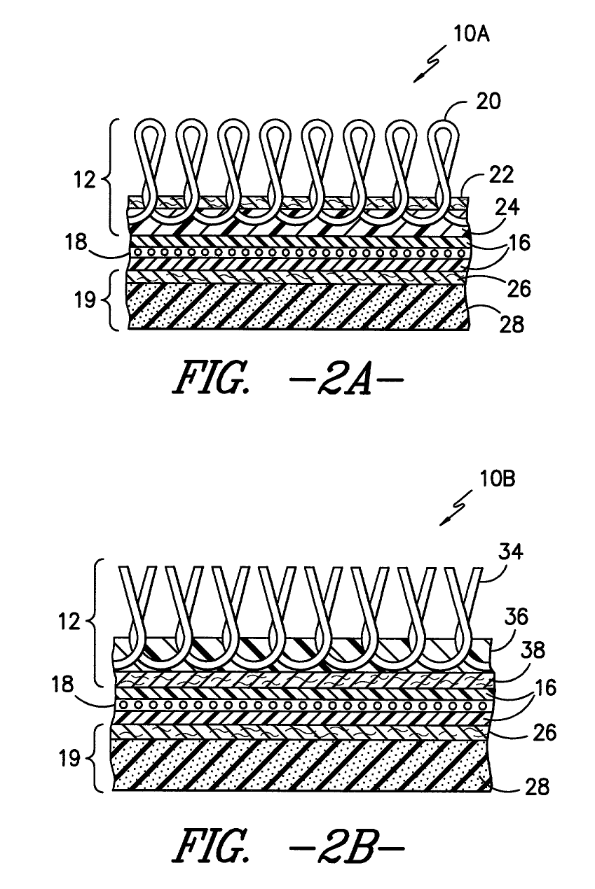

According to a preferred embodiment, the primary fabric preferably includes a plurality of pile-forming yarns projecting outwardly from one side of a primary base. If the primary fabric is a tufted carpet, its configuration will preferably conform substantially to that shown in FIG. 2A, with the difference that the pile forming yarns have undergone a tip shearing or loop cutting operation to yield a cut pile construction. If the primary fabric is a bonded carpet, its configuration will preferably be that of the bonded primary carpet illustrated in FIG. 2B.

It is contemplated that the primary fabric may include one or more backing or base layers. It is to be understood that as the primary tufted or bonded carpet fabric 12 may have different embodiments. By “primary base” is meant any single layer or composite structure including, inter alia, the commonly used layered composite of primary backing 22 and latex pre-coat 24 previously described in relation to the tufted product (FIG. 1A) and the adhesive layer 36 with reinforcement substrate 38 previously described in relation to the bonded product (FIG. 1B). As will be appreciated, the use of polyester or a stabilized material in the primary base structure may be desirable due to the eventual heat curing such structure may undergo. Other embodiments as may occur to those of skill in the art may, of course, also be utilized. For example, in the bonded product, the pile forming yarns can be heat tacked to the substrate 38 as described in U.S. Pat. No. 5,443,881 (hereby incorporated by reference herein) to permit simplified construction of a primary carpet.

Alternative embodiments including those disclosed in U.S. Pat. No. 4,576,665 to Machell (incorporated by reference) may likewise be utilized. For example, it is contemplated that specialized primary backings such as non-woven structures comprising fiberglass sandwiched between layers of polyester may be utilized in the primary tufted carpet to impart the desired properties relating to stability. Such specialized primary backing may thereby potentially reduce or even eliminate the need for the secondary backing or the latex pre-coat presently utilized in the manner to be described further hereinafter. Moreover, it is contemplated that if a pre-coat is to be utilized, it may be added directly in-line in an operation before any adhesive bonding operation.

With regard to another embodiment, in the tufted carpet construction 110A shown in FIG. 3A, the primary carpet fabric 112 preferably comprises a loop pile layer of pile-forming yarns 120 tufted into a primary backing 122 as is well known and held in place by a pre-coat layer 124 of a bonding material or adhesive such as latex, a hot melt adhesive or a urethane-based adhesive. It is contemplated that the pre-coat layer 124 may be applied to the primary backing 122 either in a preliminary processing step during formation of the primary carpet fabric 112 or may be added in-line during formation of the cushioned carpet construction. The primary carpet fabric 112 may be steamed and/or heated after addition of the pre-coat layer 124 to facilitate subsequent printing operations, such as direct or indirect jet dyeing or printing, and/or if desired to reduce stresses. Further, the primary carpet fabric 112 may be printed or dyed before addition of the reinforcement material 158 and/or layer of cushioning material or foam layer 178. Optionally, backing material 170 may be secured to foam layer 178 to create a finished appearance and a smooth backing surface.

The two basic primary backing constructions 122 are woven polypropylene and non-woven polyester. Each material may have a variety of construction characteristics engineered for a specific end use. According to one potentially preferred embodiment, the preferred primary backing material 122 is 20 pick per inch, woven polypropylene, with needle punched nylon fleece.

With regard to another embodiment, in the cut pile tufted carpet construction 110B of the present invention (FIG. 3B), the primary carpet fabric 112 preferably comprises a loop pile layer of pile-forming yarns 120 tufted into a primary backing 122 as is well known and held in place by a pre-coat layer 124 of a bonding material such as latex, a hot melt adhesive, or a urethane-based adhesive. The pile forming yarns 120 are subjected to a tip shearing or loop cutting operation to yield the cut pile construction as shown. It is contemplated that the pre-coat layer 124 may be applied to the primary backing 122 either in a preliminary processing step during formation of the primary carpet fabric 112 or may be added in-line during formation of the cushioned carpet construction. The primary carpet fabric 112 may be steamed and/or heated after addition of the pre-coat layer 124 to facilitate subsequent printing operations, such as direct or indirect jet dying or printing, and/or if desired to reduce stresses. Optionally, backing material 170 may be secured to foam layer 178 to create a finished appearance and a smooth backing surface.

The two basic primary backing constructions 122 are woven polypropylene and non-woven polyester. Each material may have a variety of construction characteristics engineered for a specific end use. According to one potentially preferred embodiment, the preferred primary backing material 122 is a 20-pick-per-inch, woven polypropylene, with needle punched nylon fleece.

In the bonded carpet construction 110C of the present invention (FIG. 3C), the primary carpet fabric 112 preferably comprises a plurality of cut pile yarns 134 implanted in an adhesive 136 such as a latex or hot melt adhesive which is laminated to a reinforcement or substrate layer 138 consisting of a woven or non-woven material which may include fiberglass, nylon, polyester, or polypropylene. It is contemplated that this reinforcement layer 138 may be pre-coated with latex or other thermoplastic polymers to permit melting adhesion with the cut pile yarns 134 upon the application of heat, thereby potentially reducing or eliminating the need for the adhesive 136.

The primary carpet yarns 120, 121, and 134 may be either spun or filament yarns and are preferably formed from a polyamide polymer such as nylon 6 staple, nylon 6 filament, nylon 6,6 staple, or nylon 6,6 filament, available from companies like DuPont in Wilmington, Del. or Solutia Fibers of St. Louis, Mo., although other suitable synthetic yarns or blends may likewise be employed as will be recognized by those of skill in the art. By way of example only and not limitation, other materials, which might be used, include aromatic polyesters, such as polyethylene terephthalate (PET) and polybutylene terephthalate (PBT); polyolefins, such as polyethylene and polypropylene; and polyvinyl polymers such as polyacrylonitrile. A variety of deniers, plies, twist levels, air entanglement, and heat-set characteristics can be used to construct the yarn. One potentially preferred material includes nylon 6,6, filament, 1230 denier, 1 ply, twisted and heat set. A potentially preferred range of deniers is from about 600 denier to about 5000 denier, while a more preferred denier size is about 1230.

Yarns 120, 121, and 134 further include monofilament nylon fibers, although polyester, polypropylene, and acrylic fibers could also be used. The monofilament fibers comprise between about 25% and about 75% of the surface of the carpet tile, and more preferably comprise between about 40% and about 45%. Because monofilament yarns are difficult to tuft by themselves, several monofilament yarns are air-entangled with one traditional carpet yarn to create a yarn bundle. Specifically, it has been found that nine ends of texturized 300 denier monofilament nylon and one end of 1230 denier nylon form an effective yarn bundle. The monofilament yarns have a preferred denier of from about 50 denier to about 600 denier, with a denier of about 300 being most preferred.

Although it may be preferred that the yarn (or fiber) be a white or light color to facilitate injection dyeing or printing thereof, it is to be understood that the yarn may be of any nature and color such as solution dyed, naturally colored, and the like, and be adapted for dye injection printing, screen printing, transfer printing, graphics tufting, weaving, knitting, or the like. In one embodiment, the nylon carpet yarns are solution-dyed a gray color, while the monofilament yarns are solution-dyed a black color to create an interesting aesthetic appearance. Solution dyed yarns having other colors, such as might coordinate with surrounding carpet tiles, may also be used. According to one embodiment, the face weight of the yarn across the carpet will be about 21.5 ounces per square yard.

In the tufted product, the adhesive pre-coat 124 is preferably styrene butadiene rubber (SBR) or latex but other suitable materials such as styrene acrylate, polyvinyl chloride (PVC), ethylene vinyl acetate (EVA), acrylic, and hot melt adhesives such as bitumen, polyurethane, polyester, polyamide, EVA, or blends thereof may likewise be utilized. As will be described further hereinafter, in the event that a hot melt adhesive is utilized, it is contemplated that a reinforcement material such as a fiberglass, nylon or polyester scrim (woven or non-woven) can be directly attached to form a composite laminate without the use of additional adhesive layers. Moreover, it is contemplated that the adhesive pre-coat 124 may be entirely eliminated in the tufted product if the loop pile 120 is tufted in suitably stable relation to the primary backing 122.

The reinforcement material 158 serves to enhance dimensional stability across the carpet construction to substantially prevent the various layers from undergoing disproportionate dimensional change as the carpet construction is subjected to compressive forces during use and temperature changes during use and/or processing. The reinforcement material is preferably a sheet, mat or tissue incorporating multiple fiberglass (glass) fibers entangled in a non-woven construction. One such construction is a 2 oz/yd² construction that may be held together by one or more binders such as an acrylic binder. Such a construction is believed to provide substantially uniform load bearing characteristics in all directions, which may be desirable in some conditions. Other materials as may be utilized include glass scrim materials as well as woven or non-woven textile materials made from polyester or nylon.

It is contemplated that a carpet construction according to the present invention including either a tufted or a bonded pile forming primary carpet fabric 112 may be adjoined to an underlying sheet of reinforcement material 158 by one or more layers of a resilient polymeric adhesive material 160. The polymeric adhesive material 160 may be of either a thermoplastic or a thermosetting composition. Hot melt materials may be particularly preferred. By way of example only and not limitation, useful hot melts may include bitumen and polyolefin-based thermoplastics. One potentially preferred hot melt material is polyolefin based thermoplastic. Useful thermosetting adhesives may include polyurethanes. It is contemplated that the total mass of hot melt adhesive utilized within both layers adjacent the reinforcement material will preferably be in the range of about 20 to about 100 ounces per square yard of carpet and will more preferably be present at a level of about 35 to about 90 ounces per square yard of fabric.

As illustrated in FIGS. 3A, 3B and 3C, the polymeric adhesive material 160 is preferably disposed in covering relation on either side of the reinforcement material 158. It is contemplated that such an embedded relation may be achieved by any number of manual or automated techniques. By way of example only, and not limitation, one such technique as may be employed is the direct application of the adhesive material 160 to each side of the reinforcement material 158 preceding insertion between the layer of cushioning or foam layer 178 and the primary carpet fabric 112. Of course it is contemplated that such application may be conducted by any appropriate means as may be known to those of skill in the art, including by way of example only and not limitation, spray coating, dip coating, roll coating, or manual application. However, notwithstanding the actual application mechanism as may be utilized, it is contemplated that the adhesive material 160 will extend in covering relation away from each side of the reinforcement material 158. In this regard, it is contemplated that the adhesive material 160 will preferably perform the dual functions of securing the reinforcement material 158 in place while simultaneously forming a bonding bridge between the underside of the primary carpet fabric 112 and the upper surface of the cushioning foam or rebond foam 178.

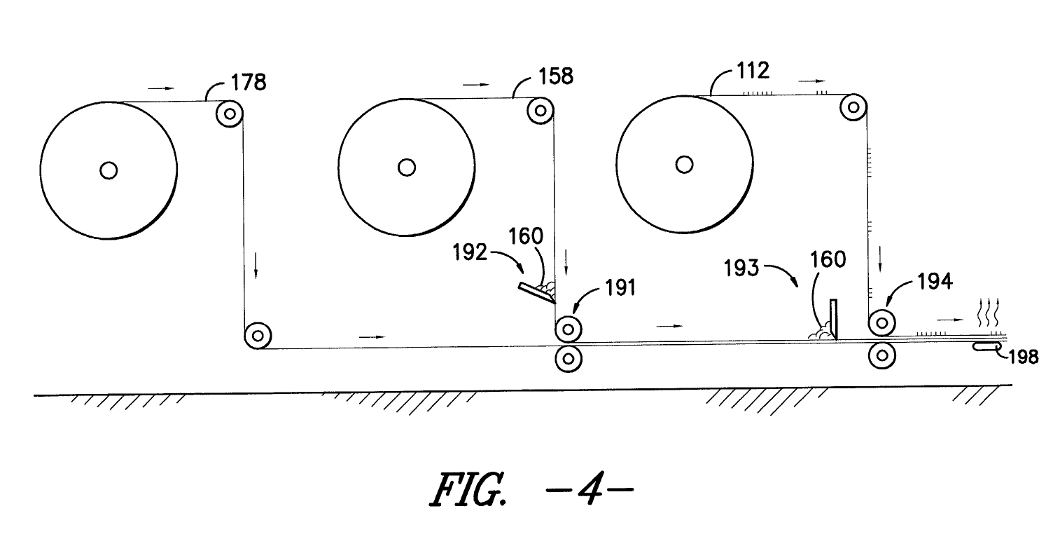

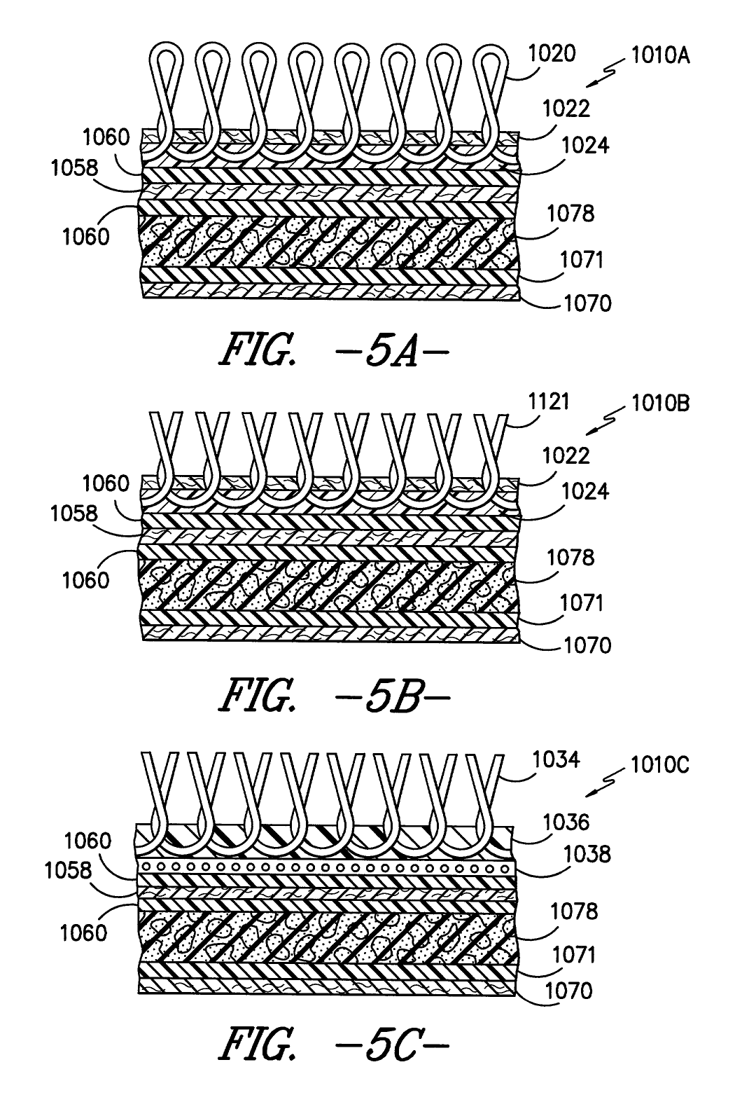

According to a simplified processing arrangement as illustrated in FIG. 4, a preformed layer of, for example, polyurethane foam, rebond foam, or compressed particle foam 178, either with or without a backing layer 170 (shown in FIGS. 3A and 3B) or a multi-component backing composite (FIGS. 5A-C), is conveyed along a travel path to a first mating calender 191 for joinder to, for example, a non-woven sheet of glass tissue, reinforcement material 158 which has been covered on its underside with a lower coating of hot melt polymeric adhesive material 160 at a first coating station 192. An additional upper coating of hot melt polymeric adhesive 160 is thereafter applied across the upper surface of the reinforcement material 158 at a second coating station 193.

As previously indicated, due to the relatively porous nature of the reinforcement material 158, it is contemplated that the hot melt adhesive 160 may be pressed through such material. Thus, it is contemplated that the first coating station 192 in FIG. 4 may be replaced with a forced spray, roll or the like if desired to deposit hot melt adhesive 160 across both sides of the reinforcement material 158 prior to lamination.

Due to the high surface area and relatively porous nature of the non-woven reinforcement material, the polymeric adhesive 160 may extend at least partially through the reinforcement material 158 while at the same time establishing a stable mechanical bond therewith. A preformed primary carpet fabric 112 as previously described is thereafter applied in overlying relation to the coated reinforcement material 158 at a second mating calender 194 such that the polymeric adhesive material 160 establishes a bond extending between the cushioning foam or rebond foam 178 and the underside of the primary carpet fabric 112. The resulting construction, which may be heated or cured at 198, is substantially as illustrated in FIGS. 3A, 3B or 3C. By adding another coating station and mating calender (not shown), another layer of adhesive (1071) can be used to attach a backing material or composite (1070) to the bottom of the foam layer 178 (FIGS.10A-10C).

The foam density of the preformed foam layer 178 is preferably in the range of about 1-25 lbs. per cubit foot, preferably about 6 to about 20 lbs. per cubic foot with a thickness of about 0.04 to about 0.5 inches, preferably about 0.04 to about 0.12 inches. According to one potentially preferred arrangement, the foam density is about 16 lbs. per cubic foot or less with a thickness of about 0.06 inches although it is contemplated that such levels may vary greatly depending upon desired product characteristics. It is believed to be advantageous for the height of the carpet tile of the present product to be equivalent, or roughly equivalent, to that of surrounding carpet tiles, to provide a uniform walking surface.

It is contemplated that the material forming the layer 180 and the preformed foam or rebond cushion 178 may be the subject of a broad range of alternatives. By way of example only and not limitation, at least four options or examples of the layer 180 and/or foam cushion material 178 are believed to be viable to yield commercially acceptable foam products using virgin polyurethane and/or recycled polyurethane chips, chunks, granules, etc.

1. Use of standard filled Polyurethane system as the virgin and/or rebond polyurethane. One polyurethane foam contains 110 parts of filler and is applied at a density of about 15 lbs/cu. ft. If the thickness is in the range of 0.04-0.12 and we determine polymer weight only, using the density and filler levels above, the weight range of the polymer would be 4.32 oz/sq yd to 12.96 oz/sq yd.

2. A second acceptable option for the virgin and/or rebond polyurethane would be to increase the filler levels to 190 and reduce the density to 13 lbs/cu. ft. At the same, the polymer weights would then be 2.72-8.24 oz/sq. yd.

3. A third option for the virgin and/or rebond polyurethane would be to use an unfilled polyurethane (Prime urethane) system. High densities such as above are not possible with prime; however, they perform because of the wall structure and the fact that no filler is present. If we consider a prime to be at 6 lbs/cu. ft. applied at the thickness limits above, the polymer weight would be 2.88-8.64 oz/sq. yd.

4. A fourth option for the virgin and/or rebond polyurethane is also possible. Textile Rubber has a polyurethane system available under the trade designation KANGAHIDE which has only 15 parts of a filler material and is applied at 6-9 lbs/cu. ft. density, if a polymer calculation is again made at the described thickness limits it would be 4.3-13.02 oz/sq. yd.

Although the above examples have to do with polyurethane, a water based foam system can also be used. Although a polyurethane rebond foam or compressed particle foam (formed of compressible particles, chips, crumbs, etc.) may be preferred, it is understood that other compressible particles made from other foams (open cell, closed cell) or materials such as SBR foam, PVC foam, polyethylene foam, cork, rubber, and/or the like may be used.

A potentially preferred polyurethane-forming composition for use as the polymer 180 and the virgin and/or rebond polyurethane chips in the rebond foam 178 of the present invention is disclosed in U.S. Pat. No. 5,104,693 to Jenkines the teachings of which are incorporated herein by reference. Specifically, the preferred polyurethane-forming composition which is used as the virgin and/or rebond polyurethane in the rebond foam and/or which is applied across the surface of the foam layer 178 includes:

(a) at least one isocyanate-reactive material having an average equivalent weight of about 1000 to about 5000;

(b) an effective amount of blowing agent; and

(c) a polyisocyanate in an amount to provide an isocyanate index of between about 90 and about 130, wherein at least 30 percent by weight of such polyisocyanate is a soft segment pre-polymer reaction product of a stoichiometric excess of diphenylmethane diisocyanate (MDI) or a derivative thereof and an isocyanate-reactive organic polymer having an equivalent weight of from about 500 to about 5,000 and wherein the prepolymer has an NCO content of about 10 to about 30 percent by weight.

The polyurethane-forming composition also preferably contains a silicone surfactant to improve frothability and stability in the form of an Organo-silicone polymer such as are disclosed generally in U.S. Pat. No. 4,022,941 to Prokai et al. the teachings of which are incorporated herein by reference. Specifically, the preferred surfactant is preferably a linear siloxane-polyoxyalkylene (AB) block copolymer and specifically a polyalkyleneoxidemethylsiloxane copolymer. One such silicone surfactant that is particularly useful is available under the trade designation L-5614 from OSI Specialties, Inc. whose business address is believed to be 6525 Corners Parkway, Suite 311, Norcross, Ga. 30092.

A sufficient level of the silicone surfactant is used to stabilize the cells of the foaming reaction mixture until curing occurs to allow the preliminary composite 166 to be laid into the uncured polyurethane-forming composition puddle 180 without destabilizing the layer of such polyurethane-forming composition disposed across the surface of the foam layer 178. In general, the silicone surfactants are preferably used in amounts ranging from about 0.01 to about 2 parts per hundred parts by weight of component (a) and more preferably from about 0.35 parts to about 1.0 parts by weight of component (a) and most preferably from about 0.4 to 0.75 parts per hundred parts by weight of component (a).

As described in U.S. Pat. Nos. 5,312,888; 5,817,703; 5,880,165; and 6,136,870 (hereby incorporated by reference) rebond foam or rebond polyurethane foam is known in the art of isocyanate-based polymeric foams. Specifically, it is known to mix pieces of foam with a binder which serves to bond the pieces to one another. Rebonding technology has been used for a number of years to recycle, inter alia, polyurethane foams. Generally, a large chip size, low density, non-uniform density, rather frangible, rebonded polyurethane foam product has been used as broadloom carpet underlayment or pad, and in specific seating and cushioning applications. Given the non-uniform and fragile nature as well as prior applications for such rebond foam, it is not surprising that these foams have not been used in cushion back carpet tile applications.

There have been efforts to recycle or re-use waste foam production, particularly waste, trim and scrap from the production of flexible foams. Flexible polyurethane foam scrap can be chopped or chipped and then coated with a binder consisting of a polyisocyanate prepolymer having isocyanate functionality and a catalyst. The coated, chopped foam is compressed and then treated with steam to cure the binder to form a rebond foam sheet or other shape.

In another process for recycling or using flexible polyurethane foam waste, the flexible foam waste is cryogenically ground and blended back into the formulation used to prepare it. The ground flexible foam can be used at a level of about 20 percent within the polyol component of the polyurethane foam formulation.

In accordance with the present invention, it is preferred to use at least about 10-90% recycled foam or rebond foam containing at least about 10-100% recycled foam chips, chunks, pieces, grounds, particles, or the like and a binder, adhesive, or prepolymer (and one or more additives) to produce a cushioned carpet composite or carpet tile having at least about 10-100% recycled foam or cushion content (especially post industrial reclaimed foam or cushion content) in the foam or cushion layer thereof.

The rebond foam sheet may have one or more materials laminated to the top and/or bottom surface thereof to form a foam or cushion composite which is laminated or attached to at least a carpet or tile material or face to form a carpet composite or product. In accordance with the present disclosure, it is preferred to use a rebond foam having a backing, such as a scrim, woven or non-woven material on at least one surface.

In accordance with the present disclosure, it is preferred to use a rebond foam or polyurethane rebond foam with a density of about 1 to 25 lbs per cubic foot, more preferably about 3-22 lbs. per cubic foot, still more preferably 10-13 lbs. per cubic foot, and most preferably 8-12 lbs. per cubic foot; a thickness of about 2-20 mm, more preferably about 2-21 mm, and most preferably about 2-7 mm; a rebond chip size (uncompressed chip size) of about 2-25 mm, more preferably about 5-15 mm, most preferably about 7-10 mm round or square hole mesh; and, a backing material or backing composite on at least one side thereof.

In a preferred embodiment, the preformed foam layer 178 may include a backing material 170 such as woven or non-woven about 10% to 100% polyester/90%-0% polypropylene, preferably about 50% polyester/50% polypropylene non-woven fibrous material or felt, such as is available from Synthetic Industries of Ringold, Ga. and which may contain a colorant or binder such as acrylic binder. While this represents the backing material of preference, it is to be understood that any number of alternative compositions or composites may likewise be utilized as dictated by requirements regarding shrinkage and installation. The commonly used secondary backing materials include non-woven polyester, non-woven polyester and polypropylene blends, or woven polypropylene. By way of example only, in instances where very little or no shrinkage may be tolerated, the backing material may be up to 100% polyester. Further, while a non-woven backing material may be preferred, it is contemplated that either woven or non-woven constructions may be utilized as can materials other than the polyester/polypropylene mix such as acrylic, nylon, fiberglass, and the like.

As has been described, the present product relates to a floor covering that is compatible for installation with surrounding carpet tiles, that is aesthetically compatible with surrounding carpet tiles, and that includes an abrasive component for removing dirt. The carpet tile of the present disclosure includes a monofilament component that aggressively dislodges dirt from pedestrian footwear. The carpet tile further includes a cushioned backing that increases the underfoot comfort to users thereof. The carpet tile can be made from solution dyed yarns or can be dyed or printed after construction.

As is traditional with carpet tiles, the shape thereof is substantially square. The width of the carpet tiles is typically about 12 inches, about 18 inches, and about 36 inches, with a width of about 36 inches being most preferred because of the ease with which they may be installed.

It is, of course, to be appreciated that while several potentially preferred embodiments, procedures, and practices have been shown and described, the invention is no way to be limited thereto, since modifications may be made and other embodiments of the principles of this disclosure will occur to those of skill in the art to which this disclosure pertains. Therefore, it is contemplated by the appended claims to cover any such modifications and other embodiments as may incorporate the features of the present product within the true spirit and scope thereof.

I claim:

1. A carpet tile comprising an upper textile surface having pile extending upwardly therefrom and a cushioned lower surface attached to said upper surface, wherein said textile surface comprises a first yarn type and at least about 25% of a second yarn type, said first yarn type being a synthetic yarn and said second yarn type being a monofilament yarn, and wherein said cushioned lower surface comprises at least one adhesive layer and at least one foam layer.

2. The carpet tile of claim 1 wherein said upper textile surface comprises a tufted substrate having loop pile extending upwardly therefrom.

3. The carpet tile of claim 1 wherein said upper textile surface comprises a tufted substrate having cut pile extending upwardly therefrom.

4. The carpet tile of claim 1 wherein said upper textile surface comprises a bonded substrate having pile extending upwardly therefrom.

5. The carpet tile of claim 1 wherein said second yarn type comprises between about 25% and about 75% of the face yarns of said carpet tile.

6. The carpet tile of claim 5 wherein said second yarn type comprises between about 40% and about 45% of the face yarns of said carpet tile.

7. The carpet tile of claim 1 wherein said first yarn type is nylon and wherein said second yarn type is monofilament nylon.

8. The carpet tile of claim 7 wherein said first yarn type has a denier in the range of about 600 denier to about 5000 denier.

9. The carpet tile of claim 8 wherein said first yarn type has a denier of about 1230 denier.

10. The carpet tile of claim 7 wherein said second yarn type has a denier in the range of about 50 denier to about 600 denier.

11. The carpet tile of claim 10 wherein said second yarn type has a denier of about 300 denier.

12. The carpet tile of claim 1 wherein said carpet tile is comprised of a plurality of air-entangled yarn bundles, each of said yarn bundles having one yarn of said first yarn type and nine yarns of said second yarn type.

13. The carpet tile of claim 1 wherein said carpet tile is substantially square and has a width selected from the group consisting of about 12 inches, about 18 inches, and about 36 inches.

14. The carpet tile of claim 13 wherein said carpet tile has a width of about 36 inches.

15. The carpet tile of claim 1 wherein said cushioned lower surface further includes at least one reinforcement layer.

16. A process for making an abrasive flooring material, said process comprising the steps of:
(a) providing a textile upper surface having a first yarn type and a second yarn type, wherein said first yarn type is a synthetic yarn and said second yarn type is a monofilament yarn; and
(b) securing said textile upper surface to a cushion backing, said cushion backing comprising at least one adhesive layer and at least one foam layer.

17. The process of claim 16 wherein said textile upper surface comprises a tufted substrate having loop pile extending upwardly therefrom.

18. The process of claim 16 wherein said textile upper surface comprises a tufted substrate having cut pile extending upwardly therefrom.

19. The process of claim 16 wherein said textile upper surface comprises a bonded substrate having pile extending upwardly therefrom.

20. The process of claim 16 wherein said second yarn type comprises between about 25% and about 75% of the face yarns of said carpet tile.

21. The process of claim 20 wherein said second yarn type comprises between about 40% and about 45% of the face yarns of said carpet tile.

22. The process of claim 16 wherein said first yarn type is nylon and wherein said second yarn type is monofilament nylon.

23. The process of claim 16 wherein said textile upper surface is comprised of a plurality of air-entangled yarn bundles, each of said yarn bundles having one yarn of said first yarn type and nine yarns of said second yarn type.

24. The process of claim 16 wherein a reinforcement layer is secured between said adhesive layer and said foam layer.
